(19) United States
(12) Patent Application Publication
(10) Pub. No.: US 2002/0166754 A1
(43) Pub. Date: Nov. 14, 2002

(54) Complex operation input device

(75) Inventors: Katsuichi Ohba, Miyagi-ken (JP); Sachiko Homma, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/136,790

(22) Filed: Apr. 30, 2002

(30) Foreign Application Priority Data
May 14, 2001 (JP) 2001-143259

(51) Int. Cl. H01H 9/00

(52) U.S. Cl. 200/4

(57) ABSTRACT

In a complex operation input device according to the invention, a rotary electrical part manipulated with an operating member and a double-action push switch unit are arranged in a layered state in a direction of a rotation axis of the rotary electrical part. As a result, the device can be reduced in lateral size, and therefore it is made possible to provide a complex operation input device which can be used with a portable digital camera particularly suitably.

### BACKGROUND OF THE INVENTION

1. Field of the Invention

The present invention relates to a complex operation input device that can be suitably used with a digital camera or the like.

2. Description of the Prior Art

To describe the configuration of a complex operation input device according to the prior art with reference to FIG. 10 and FIG. 11, a fixed member 52 is fitted above a housing 51, which is a molded synthetic resin item.

An insulating substrate 53 is fitted to the housing 51 so as to cover a receptacle 51a provided in the housing 51, and over this insulating substrate 53 is mounted a first flexible insulating substrate 54 having a plurality of fixed contacts (not shown).

A movable contact 55 consisting of a leaf spring, in a state of opposing fixed contacts provided on the first flexible insulating substrate 54, is mounted on the first flexible insulating substrate 54. As the upper part of the movable contact 55 is pressed and reversed, the movable contact 55 comes into contact with one of the fixed contacts. These fixed contacts and movable contact 55 constitute a first push switch part S3.

A second flexible insulating substrate 56 provided with a fixed contact (not shown) is arranged so as to cover the upper part of the movable contact 55, and the fixed contact provided on this second flexible insulating substrate 56 is connected by a communicating means (not shown) to the fixed contacts provided on the first flexible insulating substrate 54.

A holding member 57, which is a molded synthetic resin item, has a plate 57a and a cylindrical shaft 57b provided over this plate 57a, and this holding member 57, in a state in which its plate 57a is accommodated in the receptacle 51a, is rotatably held by pressing the shaft 57b through the fixed member 52.

A rubber contact 58 provided with a contact point is fitted within the shaft 57b so as to oppose the fixed contact provided on the second flexible insulating substrate 56.

When the upper part of the rubber contact 58 is suppressed, the rubber contact 58 is bent to come into contact with the fixed contact provided on the second flexible insulating substrate 56. These fixed contact and rubber contact 58 constitute a second push switch part S4.

As a result, the first and second push switch parts S3 and S4 constitute a two-stage suppressive switching section P2, and the first and second push switch parts S3 and S4 constituting this two-stage suppressive switching section P2 are arranged in a layered state in the direction of the rotation axis G2 of the holding member 57.

In the two-stage suppressive switching section P2, first the rubber contact 58 is pressed to operate the second push switch part S4, and its continued pressing causes the movable contact 55 to be suppressed to operate the first push switch part S3.

A slider 59 consisting of a metal plate is fitted to the plate 57a in a position outer than the two-stage switching section P2 in the radial direction, and this slider 59 comes into sliding contact with the fixed contact provided on the first flexible insulating substrate 54. These fixed contact and slider 59 constitute a rotary electrical part D2.

This rotary electrical part D2 is arranged in a radial direction orthogonal to the rotation axis G2 of the two-stage suppressive switching section P2.

A lever 60, which is a molded synthetic resin item, has a holder 60a and an arm 60b extending in one direction from this holder 60a. This lever 60, in a state of being linked so as to rotate the holding member 57, is arranged over the fixed member 52.

A key top 61 arranged to be able to suppress the rubber contact 58, in a state in which it is prevented from coming off by the holder 60a of the lever 60, is fitted to be shiftable in the direction of the rotation axis G2.

A button 63, which is a molded synthetic resin item elastically pressed by a coil spring 62, is fitted to be vertically movable in a state in which it is prevented from coming off by the arm 60b of the lever 60. This button 63 is provided with a projection 63a, which can be engaged with and disengaged from the fixed member 52. When the button 63 is suppressed against the coil spring 62, the projection 63a can come off a hole 52a of the fixed member 52 to enable the lever 60 to rotate.

A spring 64 fixed to the rotatable holding member 57 can be engaged with and disengaged from the insulating substrate 53 to form a detent mechanism, so that, when the holding member 57 rotates, the spring 64 engages with or disengages from the insulating substrate 53 to give a sense of click to the rotary action of the holding member 57 and the lever 60.

To describe the operation of the conventional complex operation input device having such a configuration, first, when the key top 61 is suppressed in the direction of the rotation axis G2, the rubber contact 58 is pressed, and the second push switch part S4 is manipulated. When the key top 61 is further suppressed, the rubber contact 58 suppresses the movable contact 55 via the second flexible insulating substrate 56, and the first push switch part S3 is manipulated.

Then, when released from suppression by the key top 61, the movable contact 55 and the rubber contact 58 automatically return to their respective original states by their own elasticity, and the key top 61 returns to its own original state with the return of the rubber contact 58.

Next, when the button 63 is suppressed against the coil spring 62, the projection 63a is disengaged from the fixed member 52 to enable the lever 60 to turn, and if in this state the lever 60 is turned with the arm 60b, the holding member 57 will rotate to turn the slider 59, which comes into sliding contact with the fixed contact on the first flexible insulating substrate 54 to cause the rotary electrical part D2 to be operated.

Then, the spring 64 engages with or disengages from the insulating substrate 53 to cause the lever 60 to turn with a sense of click.

Or if the lever 60 is released from rotation, the lever 60 and the holding member 57 will be stopped by the detent mechanism where they have turned by a prescribed angle and, if in this position the button 63 is released from suppression, the button 63 will be pushed back by the coil spring 62 to enter into a state in which the fixed member 52 is engaged with the hole 52a.

Such manipulations cause the complex operation input device to be operated.

The complex operation input device according to the prior art, in which the two-stage suppressive switching section P2 and the rotary electrical part D2 are arranged in the radial direction orthogonal to the direction of the rotation axis G2, has a large dimension in the lateral direction, and accordingly involves a problem of allowing no size reduction in the radial direction.

Especially, there is a problem that the device is unsuitable for portable items, such as a digital camera.

There is another problem that, on account of the use of the mutually separate first and second flexible insulating substrates 54 and 56, not only is an extra task of electrically connecting them needed but also their incorporation is troublesome, resulting in poor productivity.

Still another problem is that, as the second flexible insulating substrate 56 provided with the fixed contact for the second push switch part S4 is mounted over the movable contact 55 of the first push switch part S3 and, moreover, the movable contact 55 is deformed in a state in which the rubber contact 58 is in contact with the fixed contact, the contact of the second push switch part S4 is destabilized.

### SUMMARY OF THE INVENTION

Therefore, an object of the present invention is to provide a complex operation input device which permits a size reduction in the lateral direction, provides high productivity and stabilizes the contact of the double-action push switch unit.

A first means to solve the problems noted above has a configuration provided with an operating member, a rotary electrical part manipulated with the operating member and a double-action push switch unit manipulated with the operating member, wherein the rotary electrical part and the double-action push switch unit are arranged in a layered state in a direction of a rotation axis of the rotary electrical part.

A second means to solve the problems noted above has a configuration wherein the operating member comprises a rotatable knob and a key top shiftable in the direction of the rotation axis, the rotary electrical part is operated by rotation of the knob and the double-action push switch unit is operated,by shifting of the key top.

A third means to solve the problems noted above has a configuration wherein the knob is annularly shaped and arranged so as to surround an outer circumference of the key top.

A fourth means to solve the problems noted above has a configuration wherein the double-action push switch unit comprises two, first and second, push switch parts differing from each other in operating force, a carrier member is provided to support the double-action push switch unit, the carrier member has a plate, and over the plate the first and second push switch parts are arranged in a layered state in the direction of the rotation axis.

A fifth means to solve the problems noted above has a configuration wherein the first and second push switch parts click by operating forces differing from each other.

A sixth means to solve the problems noted above has a configuration further provided with a driver arranged between the key top and the carrier member and capable of shifting in the direction of the rotation axis, wherein the first and second push switch parts are arranged above and underneath the driver, one above and the other underneath, with this driver in between.

A seventh means to solve the problems noted above has a configuration wherein one of the first and second push switch parts is supported over the plate, the other of the first and second push switch parts is supported over the driver, the one suppressive switching unit supported by the plate is operated by the driver, and the other suppressive switching unit supported by the driver is operated by the key top.

An eighth means to solve the problems noted above has a configuration wherein the carrier member is provided with a guide for guiding the shifting of the driver in the direction of the rotation axis.

A ninth means to solve the problems noted above has a configuration wherein the first and the suppressive switching units comprise one flexible insulating substrate provided with fixed contacts for the first and second push switch parts and movable contacts for the first and second push switch parts, to be engaged with and disengaged from the fixed contacts, the bending of the flexible insulating substrate causes it to be mounted over the plate or the driver, one of the first and second push switch parts is arranged between the key top and the driver, and the other is arranged between the driver and the plate.

A tenth means to solve the problems noted above has a configuration wherein the double-action push switch unit and the rotary electrical part are arranged on different sides of the plate of the carrier member, and the double-action push switch unit is positioned toward the key top.

An eleventh means to solve the problems noted above has a configuration wherein the rotary electrical part is provided with a rotor rotating together with the knob, a slider provided on this rotor, and a conducting pattern provided on a flexible insulating substrate, the slider coming into sliding contact with the conducting pattern, and fixed contacts for the first and second push switch parts are formed over the flexible insulating substrate.

A twelfth means to solve the problems noted above has a configuration further provided with a supporting member for supporting the carrier member, wherein the flexible insulating substrate mounted over the supporting member is held between the supporting member and the carrier member.

A thirteenth means to solve the problems noted above has a configuration wherein the rotor is arranged between the plate of the carrier member and the supporting member, side walls provided on the rotor are in contact with or close to part of the flexible insulating substrate positioned on an outer circumference of the conducting pattern to prevent the flexible insulating substrate from floating off.

A fourteenth means to solve the problems noted above has a configuration wherein the plate of the carrier member has a shaft provided in its central part and a plurality of projections protruding from the tip of the shaft in the direction of the rotation axis, the shaft is pressed through a hole bored in the rotor to rotatably support the rotor and the knob, and the projections are pressed through holes bored in the flexible insulating substrate and the supporting member to fit the carrier member to the supporting member.

A fifteenth means to solve the problems noted above has a configuration wherein the flexible insulating substrate is held between the tip of the shaft and the supporting member.

A sixteenth means to solve the problems noted above has a configuration wherein a forcing member intervenes between the carrier member and the rotor and/or the knob and, when the rotor has rotated via the knob, the rotor is returned to its initial position by the forcing member.

A seventeenth means to solve the problems noted above has a configuration wherein a stopper to limit a range of rotation of the rotor is provided between the carrier member and the rotor and/or the knob.

An eighteenth means to solve the problems noted above has a configuration wherein the rotary electrical part has a detent mechanism and, when the knob is rotated, the knob turns with articulation.

A nineteenth means to solve the problems noted above has a configuration wherein the detent mechanism is arranged within the rotor.

### BRIEF DESCRIPTION OF THE DRAWINGS

FIG. 1 is a plan of a complex operation input device, which is a first preferred embodiment of the present invention;

FIG. 2 is a section along line 2-2 in FIG. 1;

FIG. 3 shows an exploded perspective view of the complex operation input device, which is the first preferred embodiment of the invention;

FIG. 4 illustrates how a rotor and a knob are coupled to each other and how a driver is guided in the complex operation input device, which is the first preferred embodiment of the invention;

FIG. 5 shows the under side of the rotor pertaining to the complex operation input device embodying the invention in the first mode, illustrating how a slider is fitted;

FIG. 6 shows the operation of the complex operation input device embodying the invention in the first mode, illustrating the state of its initial position;

FIG. 7 shows the operation of the complex operation input device embodying the invention in the first mode, illustrating the state of its operation;

FIG. 8 shows a development of a flexible insulating substrate in the complex operation input device embodying the invention in the first mode.

FIG. 9 shows a section of the essential part of a complex operation input device, which is a second preferred embodiment of the invention;

FIG. 10 shows a plan of the complex operation input device according to the prior art; and

FIG. 11 shows a section of the essential part of the complex operation input device according to the prior art.

### DETAILED DESCRIPTION OF THE PREFERRED EMBODIMENTS

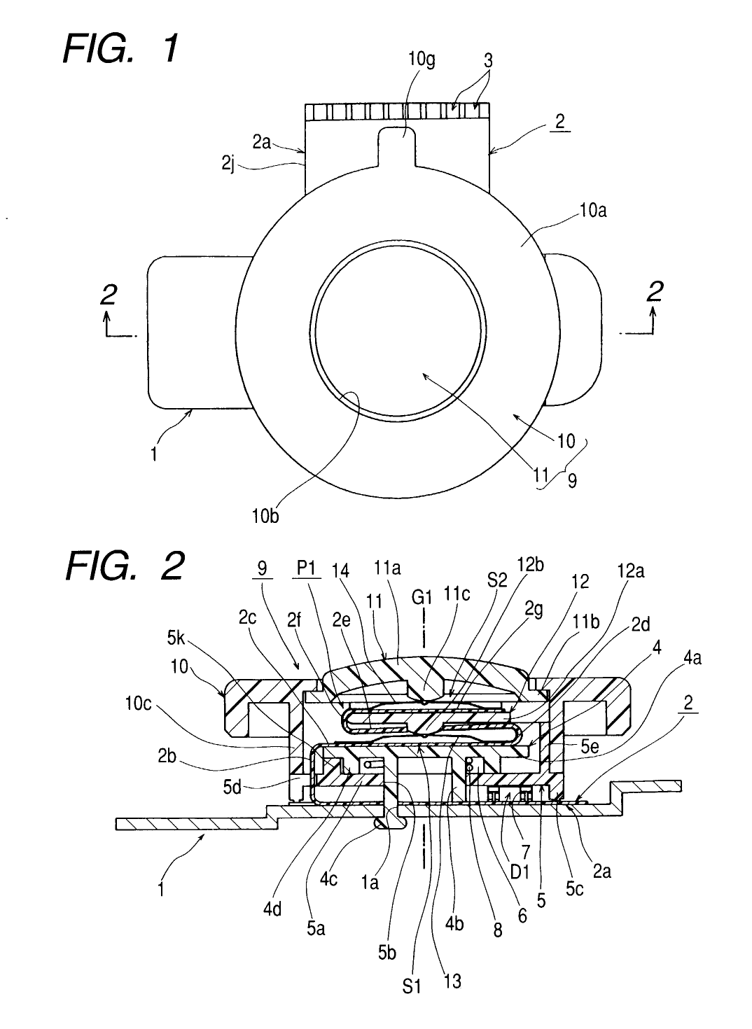

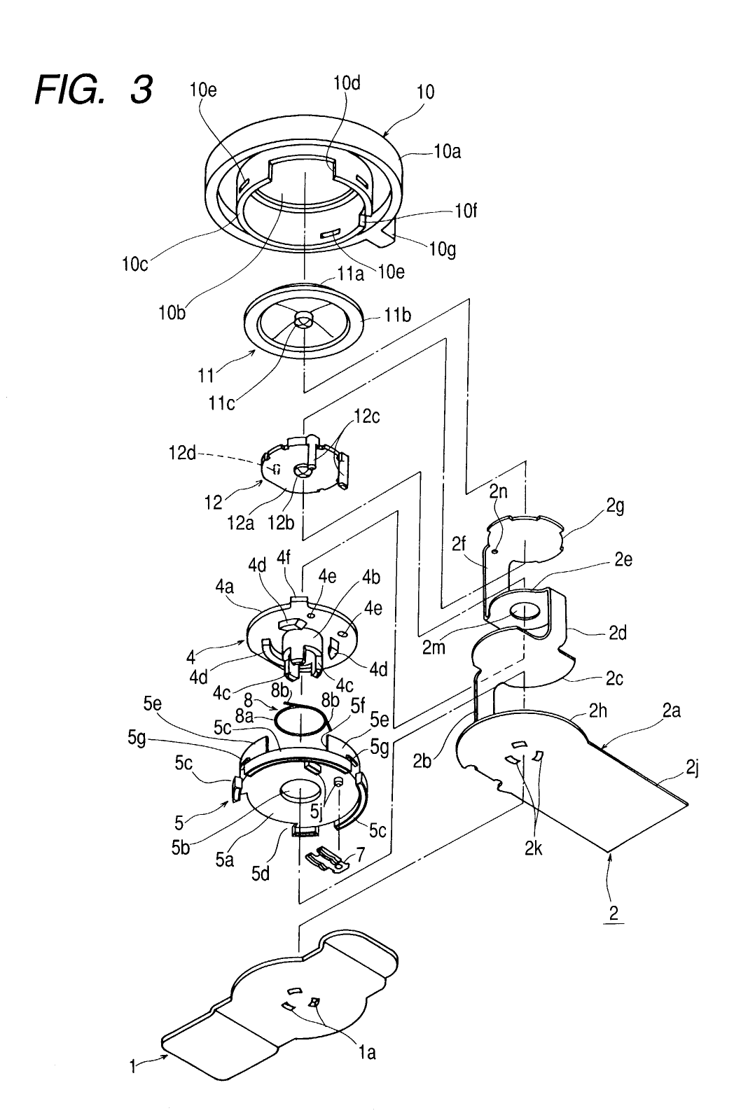

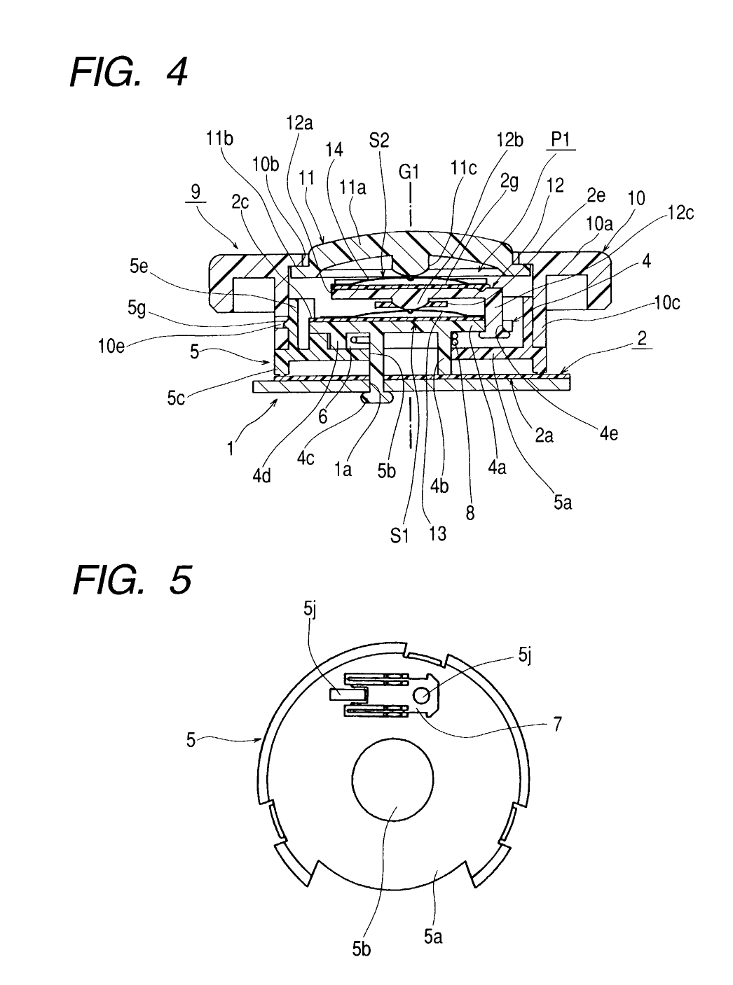

To explain drawings illustrating a complex operation input device according to the present invention, FIG. 1 is a plan of a complex operation input device, which is a first preferred embodiment of the invention; FIG. 2 is a section along line 2-2 in FIG. 1; FIG. 3 shows an exploded perspective view of the complex operation input device, which is the first preferred embodiment of the invention; FIG. 4 illustrates how a rotor and a knob are coupled to each other and how a driver is guided in the complex operation input device, which is the first preferred embodiment of the invention; and FIG. 5 shows the under side of the rotor pertaining to the complex operation input device embodying the invention in the first mode, illustrating how a slider is fitted.

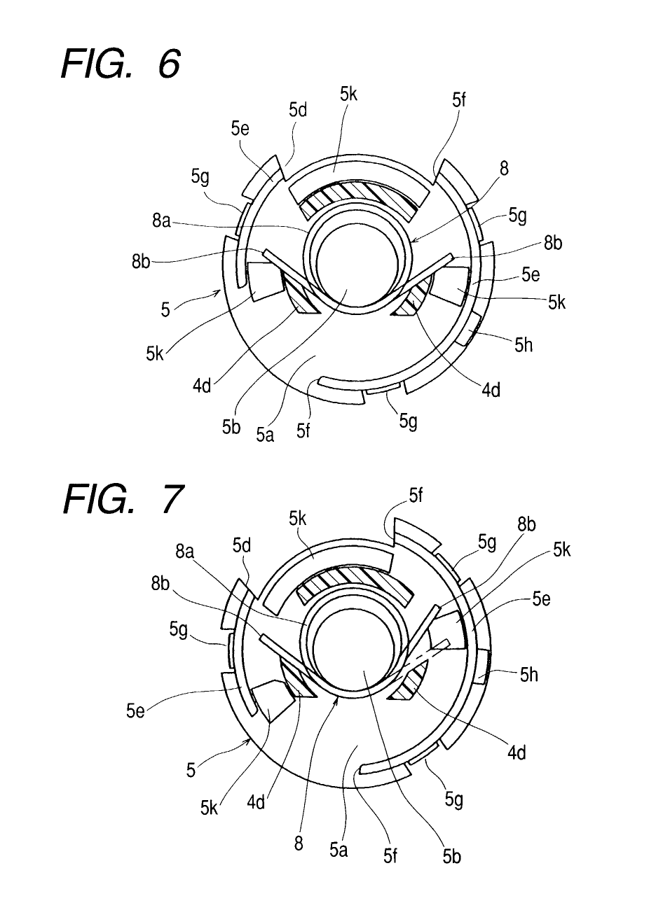

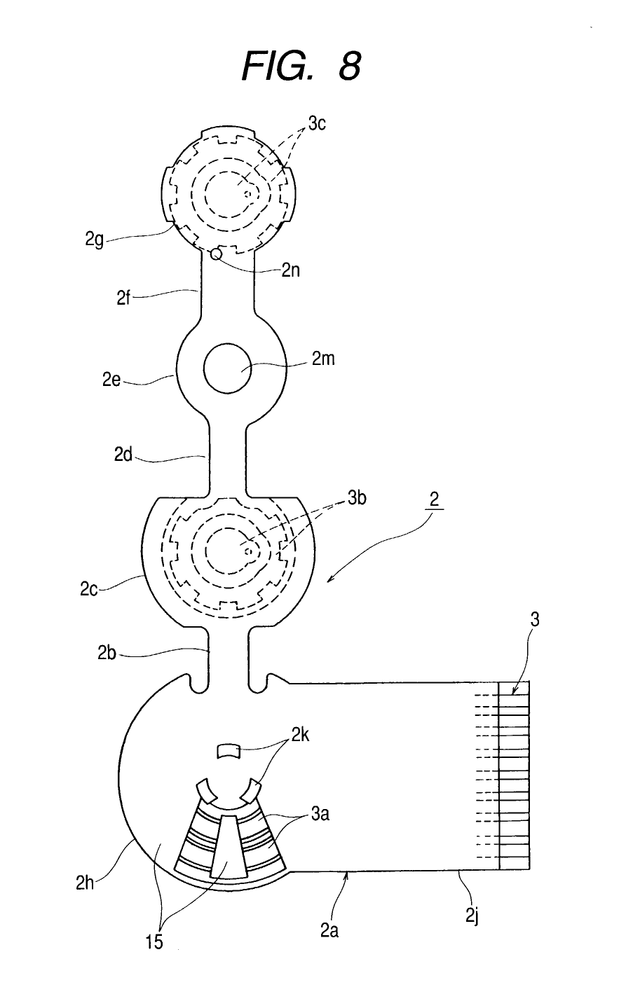

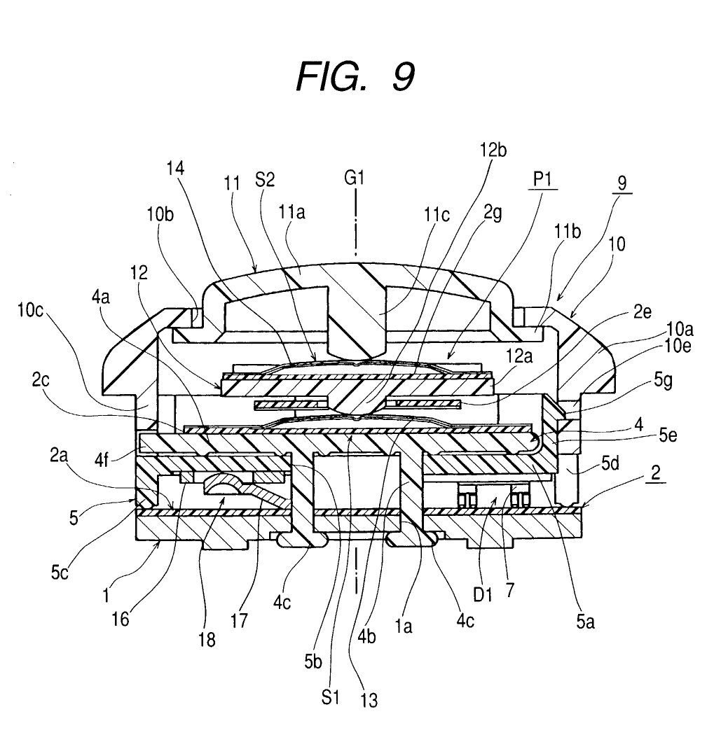

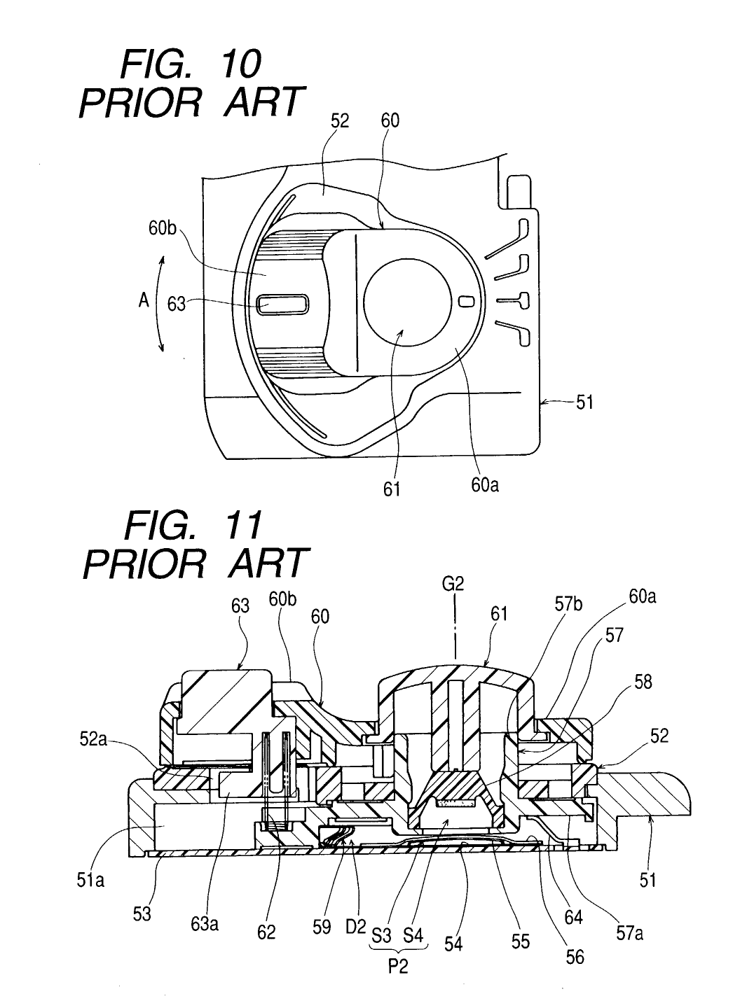

Further, FIG. 6 shows the operation of the complex operation input device embodying the invention in the first mode, illustrating the state of its initial position; FIG. 7 shows the operation of the complex operation input device embodying the invention in the first mode, illustrating the state of its operation; FIG. 8 shows a development of a flexible insulating substrate in the complex operation input device embodying the invention in the first mode; and FIG. 9 shows a section of the essential part of a complex operation input device, which is a second preferred embodiment of the invention.

Next will be described the configuration of a complex operation input device, which is the first preferred embodiment of the invention with reference to FIG. 1 through FIG. 8. A supporting member 1 consisting of a metal plate, synthetic resin or the like is planarly shaped, and in its central part has a plurality of holes 1a provided on the same circle.

A flexible insulating substrate 2 consisting of a sheet of insulating film, as shown in FIG. 3 and FIG. 8 in particular, has a planar first base 2a; a first link 2b bent upward from this first base 2a; a planar second base 2c arranged, in a state of being linked to this first link 2b, opposite the first base 2a; a second link 2d bent upward from this second base 2c and positioned on the reverse side to the first link 2b with the second base 2c in between; a planar third base 2e arranged, in a state of being linked to this second link 2d, opposite the second base 2c; a third link 2f bent from this third base 2e and positioned on the reverse side to the second link 2d with the third base 2e in between; and a planar fourth base 2g arranged, in a state of being linked to this third link 2f, opposite the third base 2e.

The first base 2a of the flexible insulating substrate 2 has a wide portion 2h and a drawer 2j linked to this wide portion 2h. The flexible insulating substrate 2 in the central part of the wide portion 2h has a plurality of holes 2k provided on the same circle, a hole 2m provided in the central part of the third base 2e, and a small hole 2n provided in the vicinity of the third link 2f of the fourth base 2g.

On the surface of this flexible insulating substrate 2, as illustrated in particular in FIG. 8, is drawn a wiring pattern 3 consisting of an electric conductor. This wiring pattern 3 has, in the position of the outer circumference of the holes 2k, a conducting pattern 3a provided on the first base 2a to constitute a fixed contact; a pair of first fixed contacts 3b provided on the second base 2c; and a pair of second fixed contacts 3c provided on the fourth base 2g. These first and second fixed contacts 3b and 3c are led to the drawer 2j by the wiring pattern 3 provided on the first, second and third links 2b, 2d and 2f and the first, second, third and fourth bases 2a, 2c, 2e and 2g, and the conducting pattern 3a is also led by the wiring pattern 3 to the wide portion 2h.

Over the flexible insulating substrate 2 is provided an insulating film (insulating resist) 15 with the conducting pattern 3a, the first and second fixed contacts 3b and 3c, and the wiring pattern 3 partly exposed, and the conducting pattern 3a is exposed on the right and left with the insulating film 15 in the middle.

In the flexible insulating substrate 2 being configured in this way, the holes 2k are matched with the holes 1a of the supporting member 1 and, with the conducting pattern 3a directed upward, the first base 2a is mounted over the supporting member 1.

A carrier member 4, which is a molded synthetic resin item, has a flat plate 4a, a cylindrical shaft 4b protruding downward from this plate 4a, a plurality of projections 4c projecting downward from the tip of this shaft 4b, three stubs 4d provided on the under face of the plate 4a to surround the shaft 4b at intervals, a guide 4e consisting of two holes penetrating the plate 4a, and a stopper 4f consisting of a convex protruding in the radial direction from the outer circumference of the plate 4a.

This carrier member 4 presses the projections 4c through the holes 2k of the flexible insulating substrate 2 and the holes 1a of the supporting member 1, and the tips of the projections 4c are heat-caulked to fit the carrier member 4 to the supporting member 1.

In this arrangement, the first base 2a of the flexible insulating substrate 2 is supported by being held between the tip of the shaft 4b and the supporting member 1 to prevent the first base 2a from floating off the supporting member 1.

A rotor 5, which is a molded synthetic resin item, has a disk-shaped base 5a, a hole 5b provided in the central part of this base 5a, a plurality of arcwise side walls 5c protruding downward from the outer circumference of the base 5a, a plurality of cuts 5d provide between these side walls 5c, a plurality of arcwise walls 5e protruding upward from the outer circumference of the base 5a, a plurality of grooves 5f provided between these walls 5e, a plurality of projections 5g protruding outward from the outer faces of the walls 5e, an engaging piece 5h (see FIG. 6 and FIG. 7) consisting of one convex projecting outward from the outer face of one of the walls 5e, a plurality of stubs 5j projecting downward from the lower face of the base 5a, and a plurality of engaging stubs 5k (see FIG. 6 and FIG. 7) projecting upward at intervals on the upper face of the base 5a.

This rotor 5 is fitted between the plate 4a of the carrier member 4 and the supporting member 1 to be rotatable around the shaft 4b, with the shaft 4b of the carrier member 4 being pressed through the hole 5b.

When the rotor 5 is fitted, the tops of the stubs 4d come into contact with the upper face of the base 5a in a state in which the plate 4a is positioned within the walls 5e, with the result that a void 6 is formed between the plate 4a and the base 5a. At the same time, in a state in which the side walls 5c surround the conducting pattern 3a, the lower ends of the side walls 5c come into contact with or are positioned close to the first base 2a to prevent the flexible insulating substrate 2 from floating off.

Also, when the rotor 5 is fitted, the flexible insulating substrate 2 has a configuration that, in a state in which the bent first link 2b extends upward through the cuts 5d and the first fixed contact 3b faces upward, the second base 2c is mounted on the plate 4a.

Further, when the rotor 5 is fitted, if the stopper 4f of the carrier member 4 is positioned in the grooves 5f of the rotor 5, the rotation of the rotor 5 causes the walls 5e positioned in the grooves 5f to hit against the stopper 4f to limit the range of rotation of the rotor 5.

A slider 7 consisting of a springy metal plate, as shown in FIG. 5 in particular, is fitted to the rotor 5 by caulking by one of the stubs 5j in a state in which it is positioned on the under face of the base 5a of the rotor 5 so that it rotates together with the rotor 5, and at the same time another of the stubs 5j, positioned in the central part of the slider 7, determines the position of the slider 7.

This slider 7 slides in contact with the conducting pattern 3a to switch from one contact to another, and this slider 7 and the conducting pattern 3a constitute a rotary electrical part D1.

A forcing member 8 consisting of a twisted coil spring has a wound portion 8a and a pair of arms 8b projecting in the radial direction from the two ends of the wound portion 8a. This forcing member 8 is accommodated in the void 6 in a state in which the shaft 4b is pressed through the wound portion 8a. As shown in FIG. 6 in particular, it is fitted in a state in which the pair of arms 8b are in contact with two of the stubs 4d and in contact with two of the engaging stubs 5k of the rotor 5.

Thus, the forcing member 8 intervenes between the rotor 5 and the carrier member 4.

As in this process the engaging stubs 5k are in contact with the arms 8b, the rotor 5 is prevented from playing and is in its initial (neutral) position.

When the rotor 5 in this initial position rotates in either the clockwise or counterclockwise direction, the rotor 5, accompanied by the slider 7 as shown in FIG. 7, hooks one of the arms 8b and rotates against the elasticity of the arm 8b to cause the rotary electrical part D1 to be operated. At the same time, when the rotor 5 has rotated by a prescribed angle, the stopper 4f hits against the walls 5e to stop the rotation.

If the rotor 5 in this state is released from rotation, the rotor 5 is returned to its initial position by the elasticity of the arms 8b for self-returning.

An operating member 9 is configured of an annular knob 10 and a key top 11 arranged in the central part of this knob 10, and the knob 10 has an annular base 10a, a hole 10b bored in the central part of this base 10a, a cylinder 10c provided to surround this hole 10b and protruding downward from the under face of the base 10a, a wide notch 10d provided in the cylinder 10c, engaging portions 10e consisting of a plurality of recesses provided in the cylinder 10c, a narrow notch 10f provided in the cylinder 10c, and a convex 10g protruding in the radial direction from the outer circumference of the base 10a.

This knob 10, in a state in which the flexible insulating substrate 2 and the carrier member 4 are positioned within the cylinder 10c, fits the walls 5e of the rotor 5 into the cylinder 10c.

Then, the projections 5g of the rotor 5 are snapped onto the engaging portions 10e of the cylinder 10c, the engaging piece 5h is positioned within the notch 10f of the knob 10 to couple the knob 10 to the rotor 5, and at the same time the rotation of the knob 10 causes the rotor 5 to turn.

Thus, with the circular hole 5b bearing the shaft 4b, the knob 10 and the rotor 5 are enabled to turn.

And the positioning of the engaging piece 5h in and its engagement with the notch 10f of the knob 10 enables the rotary action of the knob 10 to be reliably transmitted to the rotor 5.

Although the forcing member 8 intervening between the rotor 5 and the carrier member 4 in the preferred embodiment described above, when the knob 10 is turned, enables the knob 10 to return automatically, the forcing member 8 may as well intervene between the knob 10 and the carrier member 4 to enable the knob 10 to return automatically.

The regulation of the range of rotation of the knob 10 and the rotor 5 is accomplished by the coming into contact of both ends of the cylinder 10c positioned on the two sides of notch 10d of the knob 10 with the stopper 4f of the carrier member 4.

The key top 11, which is a molded synthetic resin item, has a saucer-shaped button 11a consisting of a disk, a collar 11b provided on the outer circumference of the button 11a, and a suppressor 11c consisting of a convex projecting downward from the central part of the under face of the button 11a.

This key top 11 inserts the button 11a into the hole 10b of the knob 10 from underneath, and engages the collar 11b for the prevention of coming-off with the knob 10, so that the key top 11 is fitted to the knob 10 to be vertically movable.

A driver 12, which is a molded synthetic resin item, has a disk-shaped base 12a, a suppressor 12b projecting downward from the central part of the under face of this base 12a, a pair of guide rods 12c projecting downward from the outer circumference of the base 12a, and a stub 12d projecting upward from the periphery of the upper face of the base 12a.

This driver 12 is arranged between the key top 11 and the plate 4a of the carrier member 4, and is fitted to be vertically movable in a state in which the guide rods 12c are inserted into the guide 4e of the carrier member 4 and the base 12a is in parallel with the plate 4a of the carrier member 4.

Thus, the driver 12 is vertically movable, guided by the guide 4e.

When the driver 12 is incorporated, the flexible insulating substrate 2, in a state in which its second link 2d is bent toward the driver 12 and the suppressor 12b is pressed into the hole 2m, the third base 2e is positioned on the under face of the base 12a of the driver 12, the third link 2f is bent in a U shape to place the second fixed contact 3c upward and, in a state in which the stub 12d is engaged with the small hole 2n, the fourth base 2g is mounted over the base 12a of the driver 12.

First and second movable contacts 13 and 14 consist of dome-shaped leaf springs (click springs) differing in operating force from each other. The first movable contact 13 is arranged between the carrier member 4 and the driver 12 in a state in which it is in contact with one (the outer one) of the first fixed contacts 3b and is opposite the other (the inner one) of the first fixed contacts 3b and the suppressor 12b. The second movable contact 14 is arranged between the driver 12 and the key top 11 in a state in which it is in contact with one (the outer one) of the second fixed contacts 3c and is opposite the other (the inner one) of the second fixed contacts 3c and the suppressor 11c.

The first movable contact 13 suppresses (comes into contact with) the driver 12 to support the driver 12, and the second movable contact 14 suppresses (comes into contact with) the key top 11 to support the key top 11, thereby preventing the driver 12 and the key top 11 from playing.

The first and second movable contacts 13 and 14 are held on the flexible insulating substrate 2 by adhesive tapes.

Between the carrier member 4 and the driver 12, there is arranged a first push switch part S1 consisting of the pair of first fixed contacts 3b and the first movable contact 13, and between the key top 11 and the driver 12, there is arranged a second push switch part S2 consisting of the pair of second fixed contacts 3c and the second movable contact 14.

These first and second push switch parts S1 and S2 are arranged above and underneath the driver 12 with the driver 12 in between. The first and second push switch parts S1 and S2, being arranged in a layered state in the direction of the rotation axis G1, are supported over the plate 4a.

These first and second push switch parts S1 and S2 are operated in the following manner. First, when the key top 11 is suppressed, the key top 11 shifts in the direction of the rotation axis G1 to cause the suppressor 11c to suppress the second movable contact 14, the second movable contact 14 is thereby inverted to click, and the second movable contact 14 comes into contact with the other one (the inner one) of the second fixed contacts 3c to work the second push switch part S2.

Then, as the key top 11 is further suppressed following the operation described above, the driver 12 shifts in the direction of the rotation axis G1 to cause the suppressor 12b to suppress the first movable contact 13, the first movable contact 13 is thereby inverted to click, and the first movable contact 13 comes into contact with the other one (the inner one) of the first fixed contacts 3b to work the first push switch part S1.

The first and second push switch part S1 and S2 operating in two stages as described above constitute a double-action push switch unit P1.

This double-action push switch unit P1, in a state of being positioned toward the key top 11, arranged on the different side from the rotary electrical part D1 with the plate 4a of the carrier member 4 in between, and the double-action push switch unit P1 and the rotary electrical part D1 are arranged in a layered state in the direction of the rotation axis G1.

Incidentally, the foregoing description of this embodiment of the invention assumes that the operating force of the first movable contact 13 is greater than that of the second movable contact 14, but the latter may as well be greater than the former.

Next to describe the operation of the complex operation input device according to the invention, first, as the key top 11 is suppressed in the direction of the rotation axis G1, the second movable contact 14 is suppressed by the suppressor 11c, the second movable contact 14 is thereby inverted to click, and the second movable contact 14 comes into contact with the other one (the inner one) of the second fixed contacts 3c to work the second push switch part S2.

Then, as the key top 11 is further suppressed following the operation described above, the driver 12 shifts, while being guided by the guide 4e, in the direction of the rotation axis G1 to cause the suppressor 12b to suppress the first movable contact 13, the first movable contact 13 is thereby inverted to click, and the first movable contact 13 comes into contact with the other one (the inner one) of the first fixed contacts 3b to work the first push switch part S1.

Then, when the key top 11 is released from suppression, the first movable contact 13 returns to its original state by self-reversal, the driver 12 is pressed back to its original state, the second movable contact 14 also returns to its original state by self-reversal, and the key top 11 is pressed back to its original state, i.e. the state before the suppression.

Next to describe the operation of the rotary electrical part D1, in its initial position, the slider 7 is placed over the insulating film 15, and if in this state the convex 10g of the knob 10 is held and the knob 10 is turned from its initial position (neutral position) clockwise or counterclockwise against the forcing member 8, it is turned until the rotor 5 and the slider 7 are stopped by the stopper 4f, with the result that the slider 7 comes into sliding contact with the conducting pattern 3a to work the rotary electrical part D1.

When the knob 10 is released from rotation, the rotor 5 to which the slider 7 is fitted and the knob 10 are pushed back by the forcing member 8 for self-returning to its initial position.

In this way, the complex operation input device is operated. When used in a digital camera, for instance, such a complex operation input device enables the rotary electrical part D1 to be suitably used for zooming and the double-action push switch unit P1 to be suitably used for focusing and shutter releasing.

Although this embodiment of the invention has been described with reference to a configuration in which the operating member 9 is composed of the knob 10 and the key top 11, another configuration in which only one operating member is used and this single operating member can both rotate and shift in the axial direction is also conceivable.

The first and second push switch parts S1 and S2 may either use rubber contacts and the like or be suppressive switches of some other configuration.

Also, the forcing member 8 may consist of some other springy member than a twisted coil spring and, though this embodiment is supposed to use a rotary switch as the rotary electrical part D1, it may as well be some other electrical part such as a rotary variable resistor.

FIG. 9 shows a complex operation input device, which is a second preferred embodiment of the present invention. This second embodiment has no forcing member 8, and also differs from the first embodiment described above in that neither the knob 10 nor the rotor 5 self-returns.

In this second embodiment, a click plate 16 consisting of a metal plate or the like having an uneven surface is fitted to the rotor 5 within the rotor 5, and a spring 17 to engage with and disengage from this click plate 16 is fitted to the supporting member 1.

Within the rotor 5, a detent mechanism 18 consisting of the click plate 16 and the spring 17 is arranged. When the knob 10 is turned clockwise or counterclockwise, the click plate 16 turns together with the rotor 5, and engages with or disengages from the spring 17 to rotate with articulation, also to work the rotary electrical part D1.

Since other aspects of the configuration are the same as the first embodiment of the invention, their description is dispensed with here, the same constituent elements being assigned respectively the same reference numerals.

As the complex operation input device according to the invention has the rotary electrical part D1 and the double-action push switch unit P1 manipulated with the operating member 9 arranged in a layered state in the direction of the rotation G1 of the rotary electrical part D1, it can be reduced in size in the lateral direction and can be particularly suitable when used with a portable digital camera or the like.

As the operating member 9 is composed of the rotatable knob 10 and the key top 11 shiftable in the direction of the rotation axis G1 so that the rotation of the knob 10 cause the rotary electrical part D1 to be manipulated and the shifting of the key top 11 cause the double-action push switch unit P1 to be manipulated, the two elements can be manipulated separately, resulting in a complex operation input device capable of reliable operation.

As the key top 11 is positioned in the central part and the annular knob 10 surrounds the outer circumference of the key top 11, the key top 11 is unlikely to be suppressed inadvertently, resulting in a complex operation input device capable of reliable operation.

Furthermore, as the double-action push switch unit P1 consists of two, first and second, push switch parts S1 and S2 differing from each other in operating force and is supported by the carrier member 4, with the first and second push switch parts S1 and S2 being arranged in a layered state in the direction of the rotation G1 over the plate 4a provided for this carrier member 4, the first and second push switch parts S1 and S2 can accomplish stable suppression and can be reduced in size.

Since the first and second push switch parts S1 and S2 are to click by different operating forces, different actions of the double-action push switch unit P1 can be readily distinguished from each other.

Also, the first and second push switch parts S1 and S2 consist of the movable contacts 13 and 14 the fixed contacts 3b and 3c, respectively, and the movable contacts 13 and 14 are to click, the configuration can be simple and inexpensive.

There also is provided the driver 12 arranged between the key top 11 and the carrier member 4 to be shiftable in the direction of the rotation axis G1, and the first and second push switch parts S1 and S2 are arranged above and underneath this driver 12, one above and the other underneath, with the driver 12 in between. As a result, the first and second push switch parts S1 and S2 are separated from each other by the driver 12, and can operate (turning on the contact) more reliably than similar units according to the prior art, which are stacked one over the other.

Of the first and second push switch parts S1 and S2, one is supported over the plate 4a, the other is supported over the driver 12, the suppressive switching unit supported over the plate 4a is operated by the driver 12, and the other supported over the driver 12 is operated by the key top 11, resulting in more reliable actions of the first and second push switch parts S1 and S2.

As the carrier member 4 (the plate 4a) is provided with the guide 4e for guiding the shift of the driver 12 in the direction of the rotation axis G1, the shift of the driver 12 in the direction of the rotation axis G1 is made more reliable, resulting in more dependable actions of the first and second push switch parts S1 and S2.

The first and second push switch parts S1 and S2 are composed of the single flexible insulating substrate 2 provided with the fixed contacts 3b and 3c for the first and second push switch parts S1 and S2 and the movable contacts 13 and 14 for the first and second push switch parts S1 and S2, coming into and going out of contact with the fixed contacts 3b and 3c. As the bending of the flexible insulating substrate 2 causes it to be mounted the plate 4a or the driver 12, and the first and second push switch parts S1 and S2 are arranged between the key top 11 and the driver 12 and between the driver 12 and the plate 4a, respectively, it is required only to dispose the single flexible insulating substrate 2, resulting in higher productivity and a less expensive product than according to the prior art.

Also, the double-action push switch unit P1 and the rotary electrical part D1 are arranged on the different sides of the plate 4a of the carrier member 4 and the double-action push switch unit P1 is positioned toward the key top 11, resulting in a simple configuration and greater productivity.

The rotary electrical part D1 is provided with the rotor 5 rotating together with the knob 10, the slider 7 provided on this rotor 5, and the conducting pattern 3a provided on the flexible insulating substrate 2 and being in sliding contact with the slider 7, and on the flexible insulating substrate 2 are provided the fixed contacts 3b and 3c for the first and second push switch parts S1 and S2, with the result that the single flexible insulating substrate 2 can suffice, providing greater productivity and a less expensive product than does the prior art.

Further the supporting member 1 is provided to support the carrier member 4, and the flexible insulating substrate 2 mounted on the supporting member 1 is held between this supporting member 1 and the carrier member 4, making it possible to prevent the flexible insulating substrate 2 from floating off and making the actions of the rotary electrical part D1 more reliable.

Also, the rotor 5 is arranged between the plate 4a of the carrier member 4 and the supporting member 1, and the side walls 5c provided on the rotor 5 come into contact with or are positioned close to part of the flexible insulating substrate 2 positioned on the outer circumference of the conducting pattern 3a to prevent the flexible insulating substrate 2 from floating off, resulting in further enhanced reliability of the actions of the rotary electrical part D1.

Further, the plate 4a of the carrier member 4 has the shaft 4b provided in its central part and the plurality of projections 4c protruding from the end of this shaft 4b in the direction of the rotation axis G1; the shaft 4b is pressed through the hole 5b bored in the rotor 5 to support the rotor 5 and the knob 10 rotatably; the projections 4c are pressed through the holes 2k and 1a bored in the flexible insulating substrate 2 and the supporting member 1, respectively; and the carrier member 4 is fitted to the supporting member 1 by the projections 4c, with the result that the fitting of the carrier member 4 is simplified and the flexible insulating substrate 2 can be supported at the same time as the fitting of the carrier member 4.

As the flexible insulating substrate 2 is held between the end of the shaft 4b and the supporting member 1, the flexible insulating substrate 2 can be supported at the same time as the fitting of the carrier member 4, resulting in enhanced productivity.

The forcing member 8 intervenes between the carrier member 4 and the rotor 5 and/or the knob 10, so that when the rotor 5 has rotated via the knob 10, the rotor 5 is returned to its initial position by the forcing member 8, with the result that the knob 10 can self-return and manipulating ease is ensured.

Furthermore, as the forcing member 8 is configured of a twisted coil spring, it can be fitted in a state of being held by the shaft 4b, resulting in reliable fitting of the forcing member 8.

Also, as the stopper to limit the range of rotation of the rotor 5 is provided between the carrier member 4 and the rotor 5, the knob 10 is prevented from rotating more than necessary, and the reliability of operation is thereby ensured.

Moreover, as the rotary electrical part D1 has the detent mechanism 18 and, when the knob 10 is rotated, the knob 10 is caused to rotate with articulation, the degree of rotation of the knob 10 can be readily perceived to ensure manipulating ease.

Further, as the detent mechanism 18 is arranged within the rotor 5, the whole device can be built compact.

What is claimed is:

1. A complex operation input device provided with an operating member, a rotary electrical part manipulated with the operating member and a double-action push switch unit manipulated with the operating member, wherein the rotary electrical part and the double-action push switch unit are arranged in a layered state in a direction of a rotation axis of the rotary electrical part.

2. The complex operation input device according to claim 1, wherein the operating member comprises a rotatable knob and a key top shiftable in the direction of the rotation axis, wherein the rotary electrical part is operated by rotation of the knob and wherein the double-action push switch unit is operated by the shifting of the key top.

3. The complex operation input device according to claim 2, wherein the knob is annularly shaped and arranged so as to surround an outer circumference of the key top.

4. The complex operation input device according to claim 2, wherein the double-action push switch unit comprises two, first and second, push switch parts differing from each other in operating force, wherein a carrier member is provided to support the double-action push switch unit, wherein the carrier member has a plate, and wherein over the plate the first and second push switch parts are arranged in a layered state in the direction of the rotation axis.

5. The complex operation input device according to claim 4, wherein the first and second push switch parts click by operating forces differing from each other.

6. The complex operation input device according to claim 4, further provided with a driver arranged between the key top and the carrier member and capable of shifting in the direction of the rotation axis, wherein the first and second push switch parts are arranged above and underneath the driver, one above and the other underneath, with the driver in between.

7. The complex operation input device according to claim 6, wherein one of the first and second push switch parts is supported over the plate, wherein the other of the first and second push switch parts is supported over the driver, wherein the one suppressive switching unit supported by the plate is operated by the driver, and wherein the other suppressive switching unit supported by the driver is operated by the key top.

8. The complex operation input device according to claim 7, wherein the carrier member is provided with a guide for guiding shifting of the driver in the direction of the rotation axis.

9. The complex operation input device according to claim 7, wherein the first and the suppressive switching units comprise one flexible insulating substrate provided with fixed contacts for the first and second push switch parts and movable contacts for the first and second push switch parts, to be engaged with and disengaged from the fixed contacts, wherein bending of the flexible insulating substrate causes it to be mounted over the plate or the driver, wherein one of the first and second push switch parts is arranged between the key top and the driver, and wherein the other is arranged between the driver and the plate.

10. The complex operation input device according to claim 4, wherein the double-action push switch unit and the rotary electrical part are arranged on different sides of the plate of the carrier member, and wherein the double-action push switch unit is positioned toward the key top.

11. The complex operation input device according to claim 10, wherein the rotary electrical part is provided with a rotor rotating together with the knob, a slider provided on the rotor, and a conducting pattern provided on a flexible insulating substrate, the slider coming into sliding contact with the conducting pattern, and wherein fixed contacts for the first and second push switch parts are formed over the flexible insulating substrate.

12. The complex operation input device according to claim 11, further provided with a supporting member for supporting the carrier member, wherein the flexible insulating substrate mounted over the supporting member is held between the supporting member and the carrier member.

13. The complex operation input device according to claim 12, wherein the rotor is arranged between the plate of the carrier member and the supporting member, wherein side walls provided on the rotor are in contact with or close to part of the flexible insulating substrate positioned on an outer circumference of the conducting pattern to prevent the flexible insulating substrate from floating off.

14. The complex operation input device according to claim 12, wherein the plate of the carrier member has a shaft provided in its central part and a plurality of projections protruding from the tip of the shaft in the direction of the rotation axis, wherein the shaft is pressed through a hole bored in the rotor to rotatably support the rotor and the knob, and wherein the projections are pressed through holes bored in the flexible insulating substrate and the supporting member to fit the carrier member to the supporting member.

15. The complex operation input device according to claim 14, wherein the flexible insulating substrate is held between the tip of the shaft and the supporting member.

16. The complex operation input device according to claim 11, wherein a forcing member intervenes between the carrier member and the rotor and/or the knob and wherein, when the rotor has rotated via the knob, the rotor is returned to its initial position by the forcing member.

17. The complex operation input device according to claim 11, wherein a stopper to limit a range of rotation of the rotor is provided between the carrier member and the rotor and/or the knob.

18. The complex operation input device according to claim 11, wherein the rotary electrical part has a detent mechanism and wherein, when the knob is rotated, the knob turns with articulation.

19. The complex operation input device according to claim 18, wherein the detent mechanism is arranged within the rotor.
